(19) United States
(12) Patent Application Publication
(10) Pub. No.: US 2014/0229245 A1
(43) Pub. Date: Aug. 14, 2014

(54) ON-LINE FILM FESTIVAL

(71) Applicants: David Strauss, Boulder, CO (US); Barbara Wade, Ouray, CO (US); David Corbin, Poway, CA (US)

(72) Inventors: David Strauss, Boulder, CO (US); Barbara Wade, Ouray, CO (US); David Corbin, Poway, CA (US)

(21) Appl. No.: 14/181,509

(22) Filed: Feb. 14, 2014

Related U.S. Application Data
(60) Provisional application No. 61/764,978, filed on Feb. 14, 2013.

(51) Int. Cl. G07C 13/00

(52) U.S. Cl. CPC G07C 13/00
USPC 705/12

(57) ABSTRACT

This disclosure relates generally to an online film festival allows a first user and a second user to submit a first film and a second film, respectively. The films are submitted via a digital interface and a viewer can view the submitted films through those means as well. The viewer can vote, comment on, and/or contribute funds to film of his or her choice, with the funds being contributed after presentation of the film. A vote tallying portion of the digital interface tracks and counts a number of votes associated with the film. The winning film can be determined by the number of votes or a jury.

### CROSS-REFERENCE TO RELATED APPLICATION

This application claims priority to U.S. Provisional Application Ser. No. 61/764,978, titled “ON-LINE FILM FESTIVAL,” filed Feb. 14, 2013 the disclosure of which is hereby incorporated by reference herein in its entirety.

### FIELD

This disclosure relates generally to an online film festival that includes a contest that determines awards based on popular votes and/or on jury results. Films are submitted via a website, an application, or both a website and an application, and a viewer can view submitted films through those means as well, without payment prior to viewing any of the submitted films.

### BACKGROUND

Film viewers are increasingly seeking to watch films not only in theatres, but in their homes, offices, and on mobile devices. Film viewers are also increasingly becoming savvier and more selective about what they view and what they support fiscally. The desire to see new content without paying what can amount to more than an hour's wage for many people is not appealing for those on carefully balanced budgets.

Filmmakers, including professional filmmakers, film students, novices, and hobbyists, are interested in sharing their works with audiences whom will not only give feedback that can help to improve the work, but whom might be able to support the filmmaker's efforts or a cause that is brought to light by the work. Current online venues for sharing films often requires providing a website that is maintained by the filmmaker or open the film up to commentary that is not helpful.

A venue that motivates filmmakers to produce and submit films comparable in content to those which viewers are willing to pay money for and which allows the viewers to contribute money and meaningful feedback after viewing films is needed.

### SUMMARY

Provided herein is a system that includes a digital interface accessible by a computer from a computer network, the digital interface that includes: a receiving portion configured to receive a first film from a first submitter and a second film from a second submitter, the first film and the second film each being received as a digital representation of a set of images; an information submission portion to receive information about the first and second submitters; a viewing portion configured to present to one or more viewers the first film and the second film; a timer associated with each of the first film and the second film, the timer tracking a time remaining to vote on the respective first or second film; a vote tallying portion that tracks a number of votes associated with the first and second film; and a digital forum provided by the computer network. The viewing portion also includes an input portion that is configured to receive from the one more viewers a vote, a comment, and/or funds associated with the first film and the second film, the funds being collected from at least one of the one or more viewers after presentation of the first film or the second film. The vote tallying portion also has an input for receiving data from a jury related to the first and second films, the vote tallying portion configured to determine a winning film based on the number of votes or the data from the jury. The digital forum presents data representing the winning film. The digital forum also generates promotions for the winning film, and designates a prize associated with the winning film.

The following features can be present in any suitable combination in the system described herein. In some implementations of the system, the digital interface can include a built in film school. The digital interface can include an editing service. The digital interface can include an application associated with a handheld computing device in some implementations of the system. In some implementations of the system, no funds are collected from the viewer prior to the viewer viewing the submitted film. The vote tallying system can include a system to accept votes through a text message sent through a cellular phone. The digital interface can include the ability to accept payment through a text message sent through a cellular phone. The digital interface can include a website, a dedicated application, or both a website and a dedicated application.

In a related aspect, a method for conducting a film contest is provided. The method for conducting a film contest includes receiving, via a digital interface a first film from a first submitter, and a second film from a second submitter to submit, the first film and the second film each being received as a digital representation of a set of images; accepting information about the first film and the second film via a submission portion of the digital interface from the first submitter and second submitter, respectively; presenting, via a viewing portion of the digital interface, options for a user to search and find at least one of the submitted films to view; viewing via the viewing portion of the digital interface by the user the at least one of the submitted films; accepting at least one vote via an input portion of the digital interface from the user, the at least one vote being associated with at least one of the submitted films; tallying a number of votes associated with the first and second films using a vote tallying portion of the digital interface; and generating a contest winner from the at least two submitted films, the contest winner being determined by the at least one vote or a jury.

The following features can be included in the method for conducting a film contest in any suitable combination. In some implementations, the method further includes characterizing the first and second films based upon the information provided while submitting each film. The method can further include using the vote tallying portion to determine which of the first and second films has the most votes. In some implementations, generating the contest winner comprises selecting a portion of the submitted films for the jury based upon the at least one vote. In such implementations, the method can further include submitting the first and second films to the jury using pre-determined selection criteria and announcing the contest winner via a digital forum associated with the digital interface.

In a further related aspect, a method is provided that includes providing a digital interface that allows a first submitter to submit a first film, at least a second submitter to submit a second film, and a viewer to view the at least two submitted films; accepting the at least two submitted films via the digital interface; presenting options for a user to search and find at least one of the submitted films to view; viewing via the digital interface by the user the at least one of the submitted films; accepting at least one vote via the digital interface from the user, the at least one vote being associated with at least one of the submitted films; selecting via a vote tallying portion of the digital interface a subset of the submitted films for a jury process based upon the at least one vote; subjecting the subset of the submitted films to the jury process using predetermined judging criteria; generating a contest winner from the subset of the submitted films; and announcing the contest winner via a digital forum associated with the digital interface.

In further implementations of the method, the following features can be present in any suitable combination. In some implementations, the method can also include accepting a payment associated with one of the submitted films from the viewer, the payment being made via the digital interface after the viewer has viewed the one of the submitted films. In such implementations, the payment causes the vote to be cast for the one of the submitted films. A payment can be contributed via a text message using a cellular phone. In such implementations, the payment via the text message causes the vote to be cast for the one of the submitted films. The digital interface comprises a dedicated application on a mobile computing device. In some implementations, the method can also include providing an editing service through the digital interface.

Provided herein in a related aspect is an online film festival that includes a website, an application, or both a website and an application that allows a submitter to submit a film and a viewer to view a film. The online film festival includes a submission portion of the website, application, or both website and application that accepts a film for submission and information about the film from the submitter. Also included in the online film festival is a viewing portion of the website, application, or both website and application that allows the viewer to view, vote for, share, comment on, and contribute funds towards a submitted film, wherein no funds are collected from the viewer prior to viewing any submitted film; a timer associated with the website, application, or both website and application which tracks the time available or remaining to vote on eligible submitted films; a vote tallying system associated with the website, application, or both website and application which tracks the number of votes associated with each submitted film and the origin of each vote; a jury which further critiques a predetermined number of the submitted films with the highest number of votes and determines a subset of submitted films which are deemed winners; and digital forum for announcing, promoting, and awarding prizes to the submitted films that are deemed winners, the means at least partially comprising a page associated with the website, application, or both website and application.

In a related aspect, provided is method for conducting a film contest that includes providing a website, an application, or both a website and an application that allows a submitter to submit a film and a viewer to view a film; and accepting film submissions via the website, application, or both the website and application. The method also includes characterizing submitted films based upon information provided by each submitter while submitting each film; presenting options for finding a film to view to the viewer via the website, application, or both the website and application; accepting votes via the website, application, or both the website and application from the viewer for each film viewed; using software associated with the website, application, or both the website and application to determine which films in a set time period have the most votes; selecting a portion of the submitted films for a jury process based upon votes; and subjecting selected films to a jury process with pre-determined selection criteria and generating contest winners which are announced via the website, application, or both the website and application.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE FIGURES

FIG. 1 is an exemplary flow chart indicating different choices or actions a user may execute when interacting with an online film festival.

FIG. 2A and FIG. 2B show implementations of a landing page for an online film festival showing initial choices presented to a user according to one embodiment.

FIG. 3A-FIG. 3F show implementations of pages presented to a submitter when submitting a film according to one embodiment.

FIG. 4 is an exemplary flow chart showing actions taken to submit a film.

FIG. 5A-FIG. 5D show implementations of pages presented to a viewer when viewing a film according to one embodiment.

FIG. 6A-FIG. 6C show implementations of features of an exemplary page for an individual film.

FIG. 7 is an exemplary flow chart showing actions taken to watch a film.

FIG. 8 is an exemplary flow chart showing actions executed to award prizes within an online film festival.

Like reference symbols in the various drawings indicate like elements.

### DETAILED DESCRIPTION OF THE DISCLOSURE

Filmmakers often seek an inexpensive, and optimally money-making, way to receive meaningful feedback on their work. This feedback can include viewer comments, popular votes in a contest, and feedback from a jury, including winning prizes in a contest with other filmmakers. Simultaneously, today's content users or viewers are more mobile and more cost-conscious, looking to view quality, novel content without paying an exorbitant amount before actually determining the quality of the film or other content. An online film festival is described herein that provides meaningful feedback to filmmakers in multiple ways, allows for the promotion of novel films, and allows viewers to contribute what they feel is an amount of money that corresponds to their enjoyment or value obtained from a filmmaker's submission.

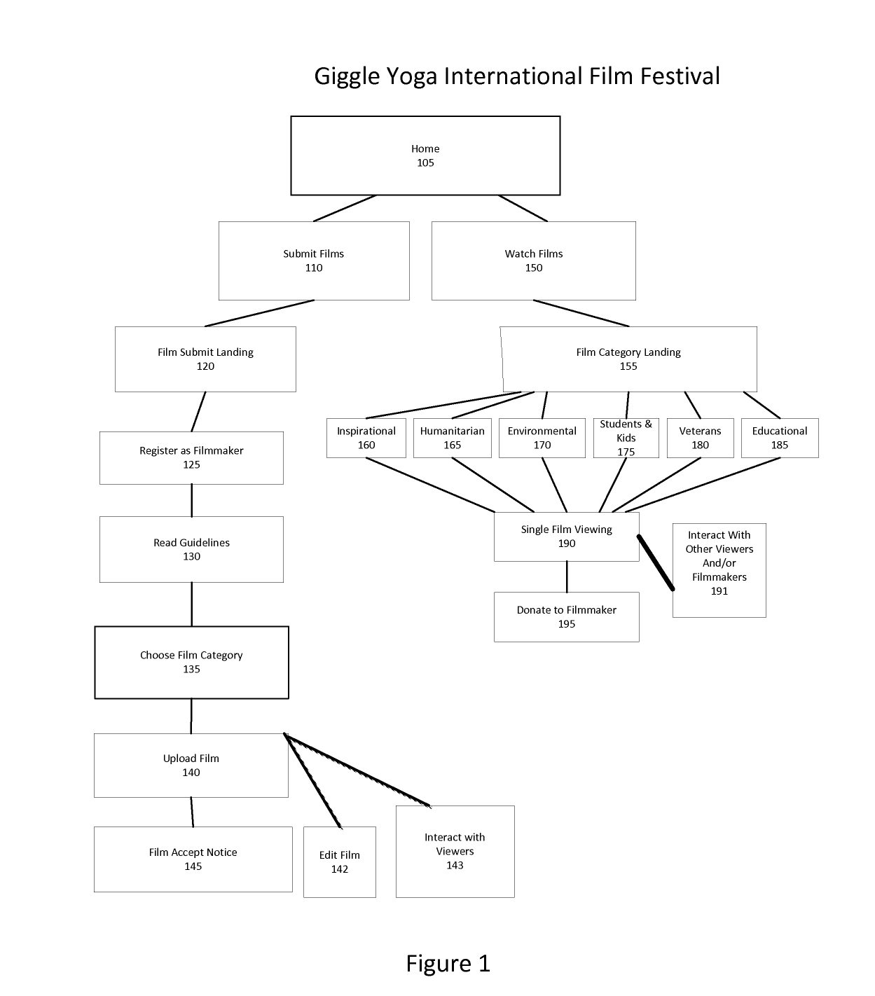

FIG. 1 shows a flow chart indicating different choices or actions a user may execute when interacting with an online film festival according to one embodiment. Each choice the user makes can correlate to a page. The decision the user can make is to visit the online film festival, which brings him or her to the home page 105. From there, the user can choose to submit a film 110 or watch one or more films 150. If the user is a filmmaker, he or she may wish to submit a film 110, and he or she begins this process at the film submit landing page 120. After reviewing content on the film, submit landing page 120, he or she can register as a filmmaker 125, read the film submission guidelines 130, choose a category for the film to be submitted 135, upload the film 140, and then receive a notice that the film was accepted 145. The user can also edit the film 142 after uploading it to the film festival. Optionally, a filmmaker user can interact with people who view his or her film 143 through chat rooms, instant messaging, online video conferences, audio-only live conversations, and the like.

A viewer may wish to watch one or more films 150. The first option that can be presented to a viewer is a listing of the film categories along with their descriptions on the film category landing page 155. The categories can include inspirational films 160, humanitarian films 165, environmentally themed films 170, films geared towards students and kids 175, films geared towards military veterans 180, educational films 185, and any other type/category of films. After selecting a category (or genre) and then selecting a particular film, a new tab or window can open up for viewing the selected film. This window or tab will be dedicated to the single, selected film 190. After viewing the film, the viewer can have the option of interacting with other viewers or the filmmaker 191 about the film or donating to the filmmaker or a charity designated by the filmmaker 195.

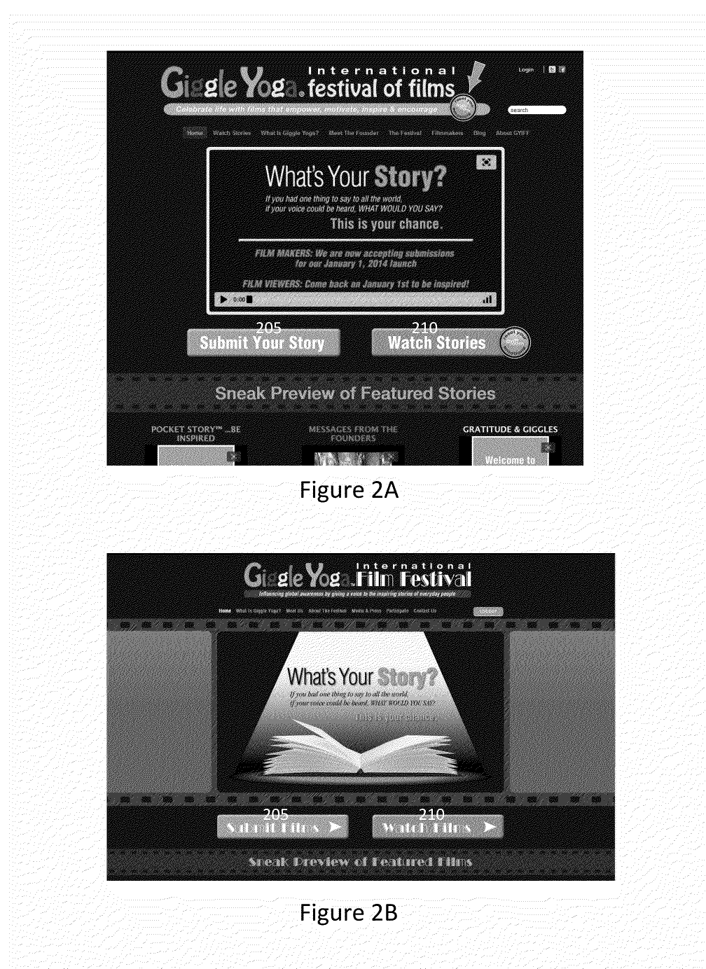

FIGS. 2A and 2B show two implementations of a landing page for an online film festival showing initial choices presented to a site visitor. As mentioned above, the user initially has the option to submit films 205 or to watch films 210. This landing page can additionally feature a short list of the most popular films, the most recent award-winning films, brief information about the most current or upcoming film-festival contests, and the like.

Submitting a Film to the Online Film Festival

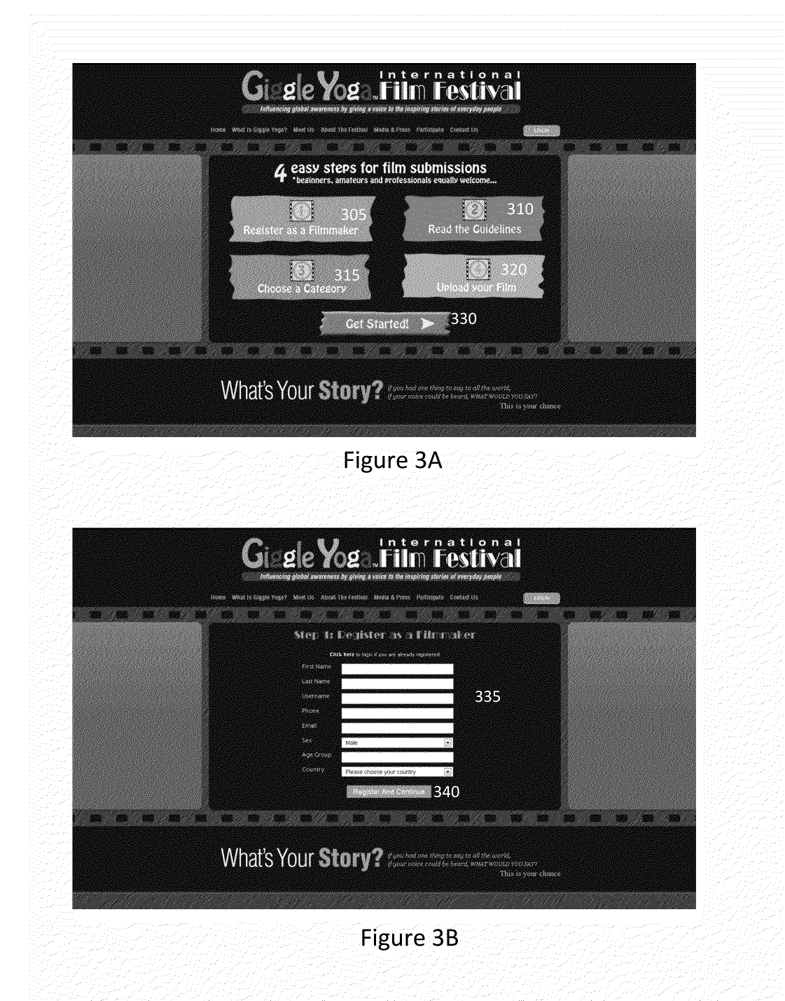

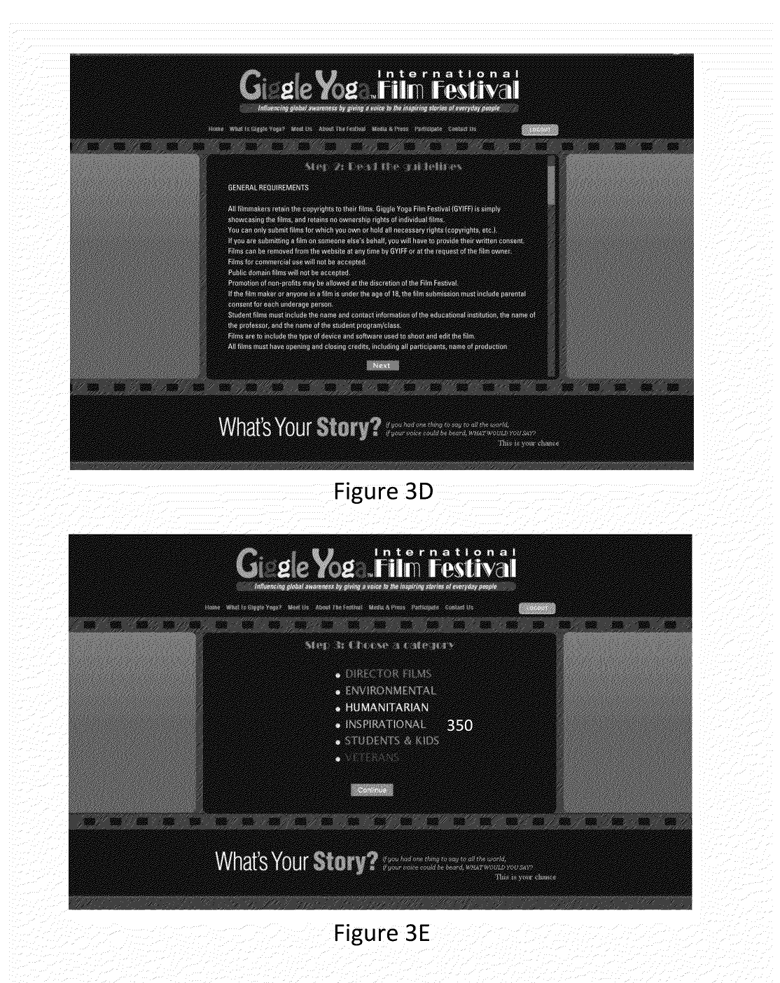

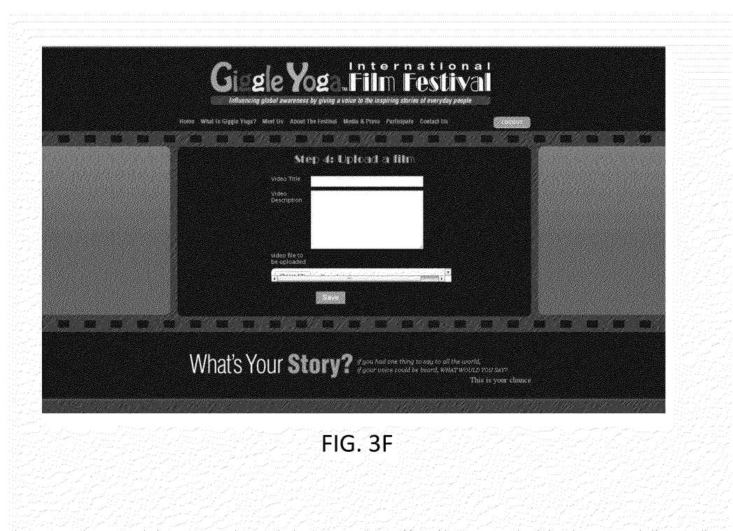

FIG. 3A-FIG. 3F show pages presented to a user when submitting a film according to one embodiment. FIG. 3A shows a page that summarizes the steps involved in submitting a film. The steps can include registering as a filmmaker 305, reading the submission guidelines 310, selecting a category for the submission 315, and uploading the film 320. A button or link to continue the process 330 can be present.

FIG. 3B is an exemplary filmmaker registration page. The filmmaker information is entered into the fields, 335, and then the user elects to continue 340. FIG. 3D is a presentation of exemplary guidelines for participating in the online film festival as a filmmaker. Additional exemplary guidelines and agreements can be found in the Appendix of U.S. Provisional Patent Application 61/764,978, the contents of this application in its entirety are hereby incorporated by reference herein. FIG. 3E shows how the online film festival software, either on a server or through the website, allows the user to designate a category 350, or genre, for his or her film submission. FIG. 3F shows exemplary fields that can be presented to the user when it is time to upload a film for submission.

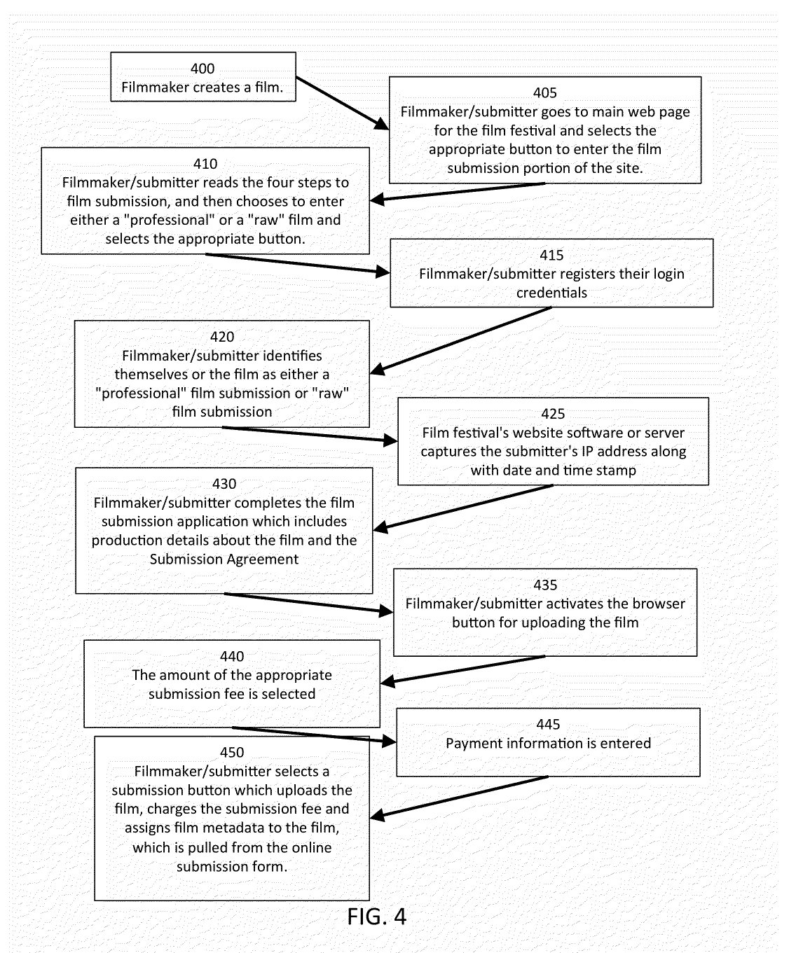

FIG. 4 is a flow chart showing actions taken to submit a film according to one embodiment. A filmmaker creates a film 400. The film can be a “raw” or “pocket story” film. A “raw” or “pocket story” film is usually unedited and shorter in length, such as limited to ten minutes or less. In some implementations, a “pocket story” can be edited, but will still be limited in length to a short time period, such as ten minutes or less. A “raw” film or “pocket story” film can be created with a hand-held mobile device, such as a digital camera, tablet computer, or smartphone and then uploaded to the online film festival via a digital interface, such as a mobile version of the online film festival's website or a dedicated application, or app, on the hand-held device. The subject of “raw” films or “pocket story” films can include stories of transformation from hardships through courage, unheard stories of everyday people, or short stories that are generally inspiring, uplifting, heartfelt and fulfilling.

Alternatively, the film can be a “professional” film. “Professional” films can be as long as the competition allows (such as less than one hour, less than one and a half hours, less than two hours, between one and two hours, and the like), and usually will have post-production processing, such as editing and added sound. “Professional” films can be categorized into broad categories. Such broad categories can include: gratitude &giggles, messages from the founders, humanitarian, veterans, students, non-profits, and the like.

Films that can be included in the gratitude & giggles category are fully edited short independent films that can create a collection of inspiring and uplifting stories. Such stories can make a viewer giggle and laugh, can be about real-life stories which make you feel good, can celebrate triumphs over tragedy, and can include true stories of heroism.

The messages from the founders can include films that are largely promotional in nature, encouraging participation in the online film festival, describing the goals of the online film festival, and the like. These messages can include inspiring messages from the founders of the online film festival, messages from motivational speakers, interviews with sponsors and other special guests, discussions and interviews about some films, and more information about filmmakers and other individuals associated with the online film festival.

Humanitarian films can be made with the aim to elevate awareness about pressing global humanitarian issues, describe how a viewer can alleviate suffering and improve the welfare of those less fortunate, and illustrate how all people and life forms are energetically connected.

Films in the veteran's category can include those films that honor veterans. These films can provide stories of courage, hope, and inspiration, as well as potentially providing messages of peace as shown from the perspective of military or was veterans. Additionally, films in the veteran's category can bring to light the human cost of war.

Students are encouraged to participate in the online film festival and can choose to enter in the student category. A student is defined as a person aged 26 years old or younger who is enrolled in an educational institution. The student category can include subcategories that reflect the broad categories of veteran films, humanitarian films, pocket stories, gratitude and giggles, and the like.

In box 405, the filmmaker/submitter selects the appropriate button to enter the film submission portion of the site from the digital interface, for example the main website or the application landing page. Following this, filmmaker/submitter reads the steps to submit a film and selects whether to enter as a “raw” film or a “professional” film 410. The filmmaker/submitter then registers his or her login credentials 415 and identifies him or herself or the film as a “raw” or “professional” submission 420. The software or hardware behind the website or application captures the submitter's IP address along with a date and time stamp 425. The filmmaker/submitter then completes the film submission application that includes production details about the film, as well as the Submission Agreement, as in box 430. The uploading process begins as the filmmaker/submitter activates the browse button for uploading the film 435. The software then indicates the possible fees to pay, and the user selects the appropriate submission fee 440, then payment information is entered 450, either through a service such as PayPal®, directly using a credit card, directly using bank information, through some other service, or the like. The filmmaker/submitter then selects a submission button that uploads the film, charges the submission fee, and assigns film metadata to the film 450. The metadata is obtained from the online submission form filled out by the filmmaker/submitter.

The film submission can be done from a desk-top computer, a lap-top computer, a tablet computer, smartphone, mobile phone, other hand-held computing device, or any other computing device capable of storing a movie file and communicating with the internet or an external server. A website can present the film submission options to a filmmaker/submitter. Alternatively, a submission can be made through a dedicated application, such as an application (i.e. app) on a smartphone or tablet device.

The application for a computing device can include an application for a desktop or laptop computer and an app for a mobile phone, smartphone, or tablet. The application can recognize video recording devices integrated into or connected to the computing device and directly accept a video stream from such an integrated or connected device. In some instances, the application can control the operation of the integrated or connected video recording device to control the starting and stopping of recording, frame rates, focus, lighting adjustment, panning, steadiness adjustments, and the like. The dedicated application can provide a user, such as a filmmaker/submitter, with a direct connection to the online film festival, for quick transferring of his or her film. The user can also use the application to edit his or her film. Editing features can include the incorporation of sound, splicing the film, fading and other transitions, introducing subtitles, adding credits, and other post-production activities.

The online film festival can provide an editing service to its users. The editing service can be separate from the application and can allow a user to edit a film that he or she uploads. Editing features provided by the editing service can include the incorporation of sound, splicing the film, fading and other transitions, introducing subtitles, adding credits, and other post-production activities.

The editing service can be part of a built-in film school provided by the online film festival through the film festival's website, dedicated application, or both the website and dedicated application. The built-in film school can instruct filmmakers/submitters on how to use basic editing tools and how to create interesting stories by selecting the order in which to present information in their films. Basic editing tools can include those described above with respect to the editing service. Alternatively, the built-in film school can be separate from the editing service, with the built-in film school providing instruction and advice only.

Films can be recorded and submitted as a digital representation of a set of images in any suitable format, as well as created from any suitable collection of images. The images can be in the form a collection of TIFF, JPEG, PDF, bitmap, RAW, or other digital format. The films can be recorded and uploaded as a MPEG file, such as MPEG-1, MPEG-2, MPEG4, CCIR 601 format, H.261, H.263, H.264, Theora, or any other suitable digital video format. The films can be displayed in any suitable format, compatible with the digital interface the viewer is using. Conversion of the film from the file type used to upload the film to the one used to view the film can be done by the digital interface either upon uploading the film or upon displaying the film to the viewer.

Viewing Films Using the Online Film Festival

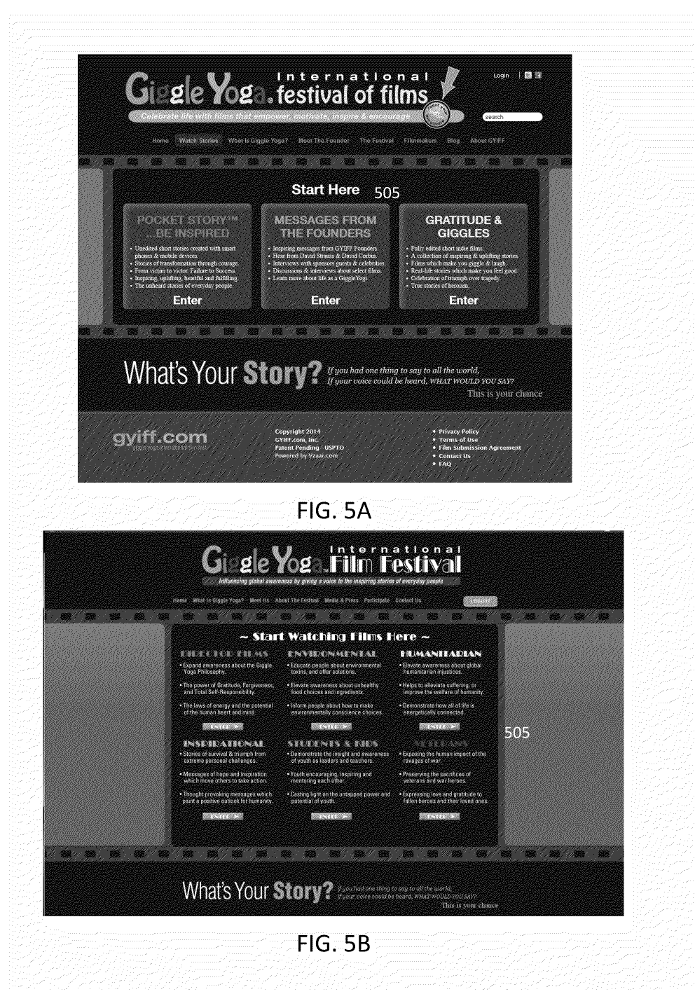

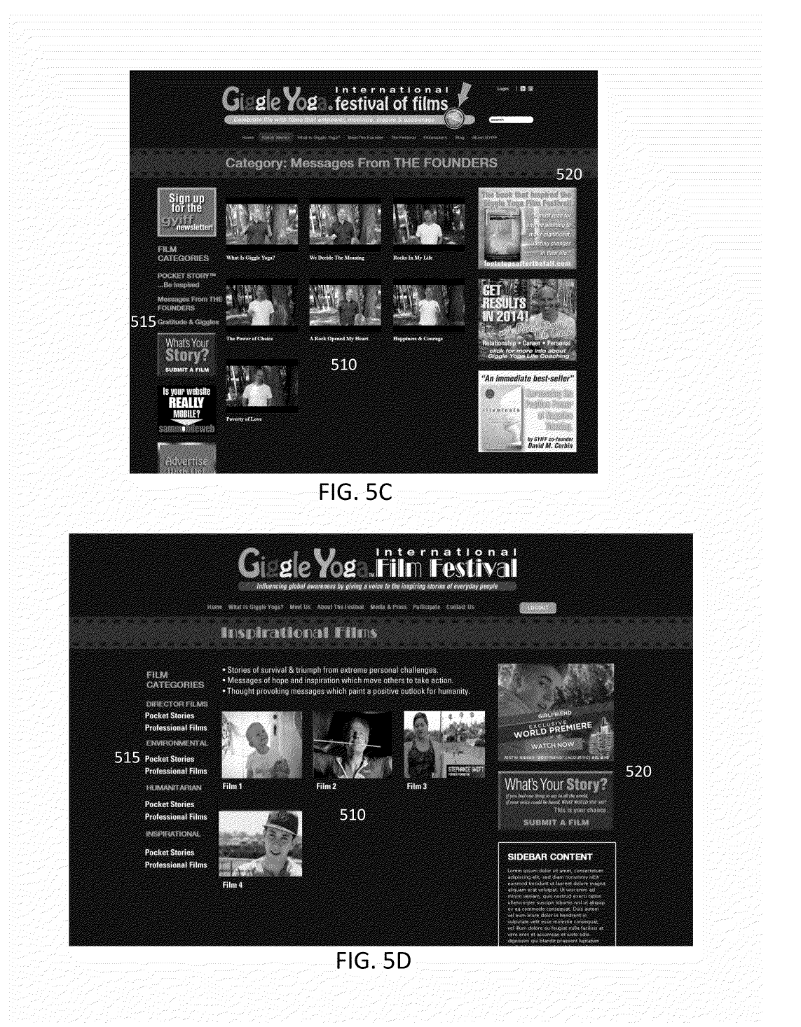

FIG. 5A-FIG. 5D show examples of pages presented to a viewer when viewing a film. FIG. 5A and FIG. 5B are implementations of a first page shown to a viewer after selecting to watch a film. The film categories, or genres, 505 are listed with their respective description. Implementations of a page showing all of the films in a particular category are shown in FIG. 5C and 5D. A listing of all of the categories 515 is provided for easy navigation, and thumbnails of all of the films 510 are presented in the center of the page. The other side of the page can have advertisements, announcements, and other content 520.

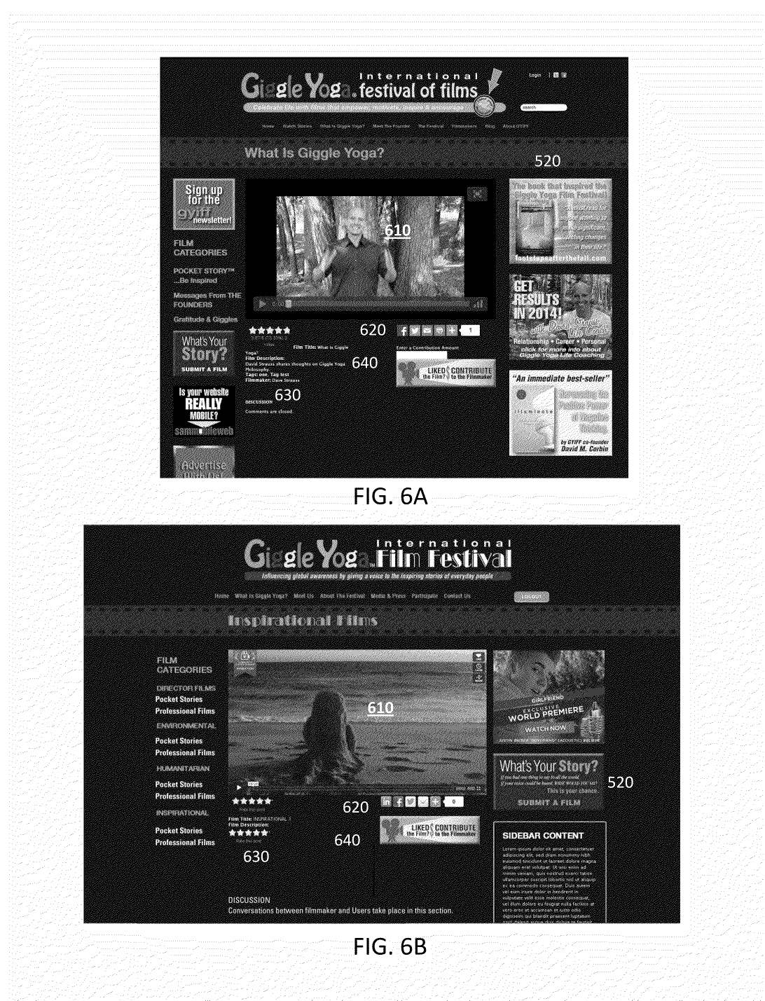

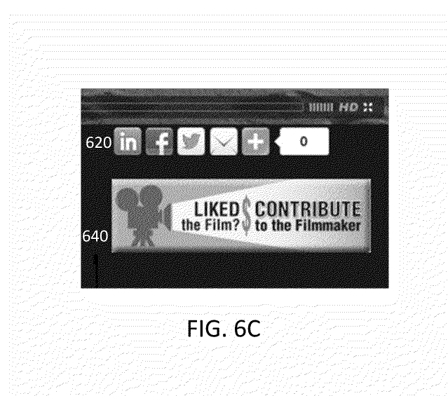

FIG. 6A-FIG. 6C show features of an exemplary page for an individual film. FIGS. 6A and 6B show implementations of a page for an individual film. On the page for an individual film is similar “side bar” content 520, including advertisements and announcements. In the center is the portion of the window where the film can play 610, if a full-screen option is not selected. Underneath the viewing portion 610, are buttons or links to social media tools 620, so that a viewer can share or publicly discuss what he or she has seen. Comments 630 can be displayed on this page, and when comments 630 are made, they can be displayed under the viewing portion 610. Also present on the page is a button or a link that allows a viewer to contribute financially to the filmmaker or a charity selected by the filmmaker 640. FIG. 6C is a closer view of that button 640. The button or link 640 may not be active until after the viewer has watched a pre-defined portion of the film, or it can always be active. The appearance of the button 640 can change to suit the nature of the contribution, whether it is to the filmmaker or a charity. The button or link 640 can also serve as a voting button. Alternatively, if a contribution is made, a vote can be automatically cast along with the contribution. Otherwise, a separate voting button can be present on the page shown in FIG. 6A and FIG. 6B. The voting functionality may be limited in a manner such that one viewer cannot vote in excess of a predetermined number of times, such as no more than three times, no more than five times, no more than ten times, or the like. Such a limitation can be based upon a user login, IP address, or the like. Alternatively, the viewer can be limited to a certain number of vote(s) per hour, day, week or the like.

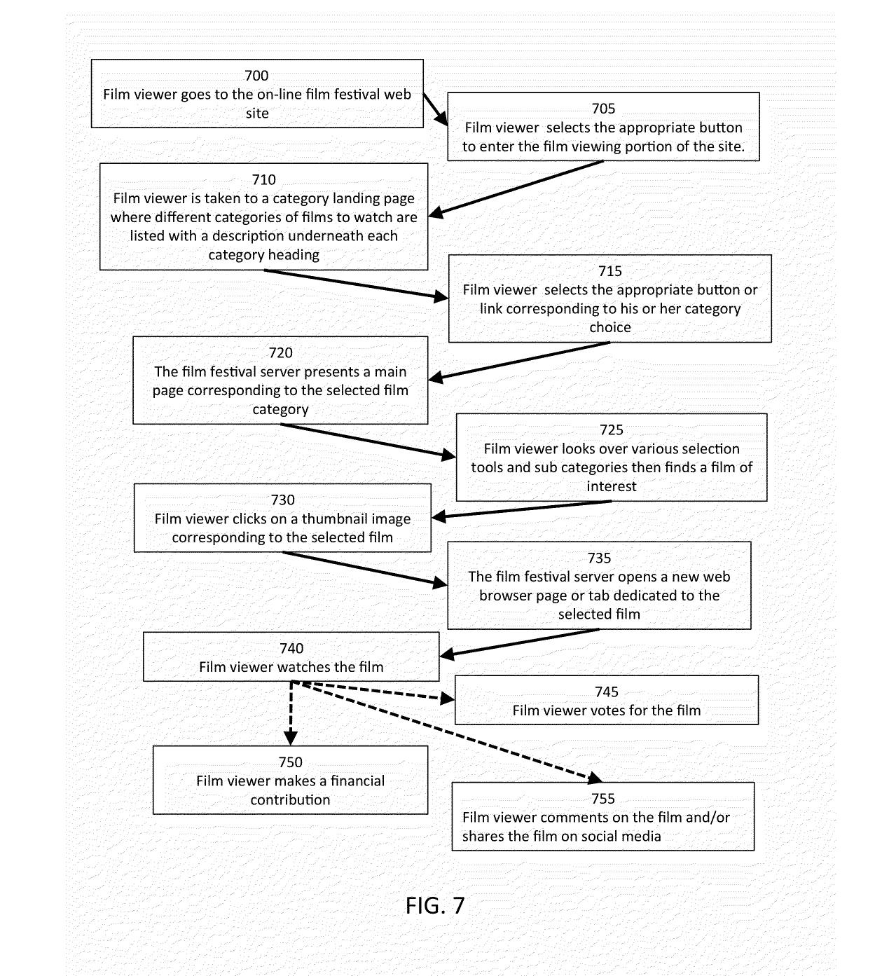

FIG. 7 is a flow chart showing actions taken to watch a film. The first step is for a user to go to the online film festival digital interface, such as a website or application 700. From there, the viewer selects the appropriate button or link to enter the film viewing portion of the digital interface 705. A category landing page is then presented to the film viewer 710, and then the viewer selects the appropriate link or button corresponding to his or her category choice 715. A main page corresponding to the selected film category is presented 720, and then the viewer can find a film of interest using a variety of tools 725. The tools for searching can include a search field linked to a site specific search engine, a breakdown of the categories into sub-categories, and the like. Once the viewer has selected an individual film, he or she clicks on the thumbnail image of the film 730 and a new page or tab dedicated to the selected film can be opened 735. From this dedicated page, the viewer can watch the film 740. After watching the film, the viewer has the option to do all, some, or none of the following: vote for the film 745, make a financial contribution to the filmmaker or a selected cause 759, leave a comment or share the film on social media 755.

The financial contribution aspect of the viewing experience is optional and flexible. This allows a viewer to be less wary that they will potentially lose money, as well as their time, viewing a film that they know little about. The viewer can decide if the film is worthy of a financial contribution after viewing the film instead of before viewing the film. A viewer can pay any amount he or she would like. This honor and satisfaction based payment system can have many names. This payment process can be called a “Grati-ticket”, “GratiTik”, “KarmaTik”, “Gratibution,” or the like.

Additionally, this honor and satisfaction based payment model can give financial incentive to filmmakers to submit unreleased films or to create new films, can create a pathway through which non-profits can raise donations for their 501(c)(3) cause, can motivate the general public to share their human interest stories, can allow any person with a compelling story to generate personal income, allows for real-time collection of donations and daily pay-outs for beneficiaries (if needed), and can generate revenue for the online film festival through a percentage fee charged on income from the contribution button or link.

Financial contributions can be remitted in various ways. The contribute button can lead to a separate page where payment information can be given by a user. In dedicated applications or when a user has registered to use the film festival site, the contribute button can cause a user defined amount to be remitted to the filmmaker or designated cause, without the user inputting payment information. In such cases, a confirmation code, personal identification number (PIN), or other means of authentication can be used to confirm the user intended to submit the contribution. Any forms of electronic payment can be accepted, such as electronic funds transfer, credit card payments, payments using third-party payment software, payments through text messages sent on a cellular or mobile telephone, and the like. Payment options can also include the ability to be sent a paper bill, in response to which a user can send a check or money order. In the instances where payment can occur using a text message via a cellular or mobile phone, the user can also vote for a film with his or her payment text message.

Interactions via the Online Film Festival

Filmmakers, viewers, and financial backers can interact via the online film festival in many ways, with varying degrees of real-time interaction. Means of interaction include individualized virtual theatres, walls for postings, follower status for online film festival users, discussion forums, searching functions for discussion topics and threads, video conferencing, affiliate participation, and the like.

Filmmakers who participate with multiple films can each have an individualized virtual theatre. There, each filmmaker can collect his or her films and can comment on films individually or collectively, provide information about the making of the films, and provide information about upcoming projects.

Filmmakers can have a virtual wall, or a dedicated portion of their profile, where postings are displayed. Postings can include random thoughts, information on current projects, information about future projects, comments on past films, information about meetings or the availability to meet, and the like. Postings can simultaneously be distributed to the filmmaker's other social networking outlets, and postings of particular filmmakers can be selected for display on designated sections of the online film festival's website or dedicated application. Viewers and other filmmakers can choose to be alerted when the filmmaker posts to his or her virtual wall by becoming a follower, or fan, of the filmmaker.

The online film festival can increase the likelihood that a viewer will find films that interest him or her, as well as discussions of interest, by including searching tools, both on the film festival's website and dedicated application. Searching tools can utilize searches on the entire contents of discussions and postings to return search results, or the tools can rely on keywords that the author of the discussion comment or posting has associated with the content.

Written interaction between any of the online film festival's users, both viewers and filmmakers/submitters, can include posts, instant messages, comments, written discussion groups or boards, direct e-mails, and the like. In addition to written interaction, the online film festival can provide a platform for verbal interaction, such as a discussion held in real-time with participants calling in using telephones or VOIP technology. In some instances, the verbal interaction can also include video feeds, so that a real-time video-conference can be held using the online film festival's website, dedicated application, or a combination of the website and dedicated application. Such verbal, real-time interaction can allow users to learn from each other, such as by sharing filmmaking tips, editing skills, financing or advertising ideas, and the like.

Interactions can also occur through affiliate activities. Affiliate activities can include the sale of merchandise related to the online film festival or films available through the online film festival. Affiliate activities can also include advertising and promotion of the online film festival on an affiliate website in which the website owner or administrator will receive a portion of submission fees that can be traced to film submissions generated by the affiliate website. The website can go through a selection process, such that the owner or administrator of the affiliate website applies to become an affiliate and persons or algorithms designated by the online film festival determine whether the website's application is accepted. The criteria for acceptance as an affiliate website can include compatible content, traffic history, regular maintenance of the website, sizable user base, and the like.

Judging and Awards within the Online Film Festival

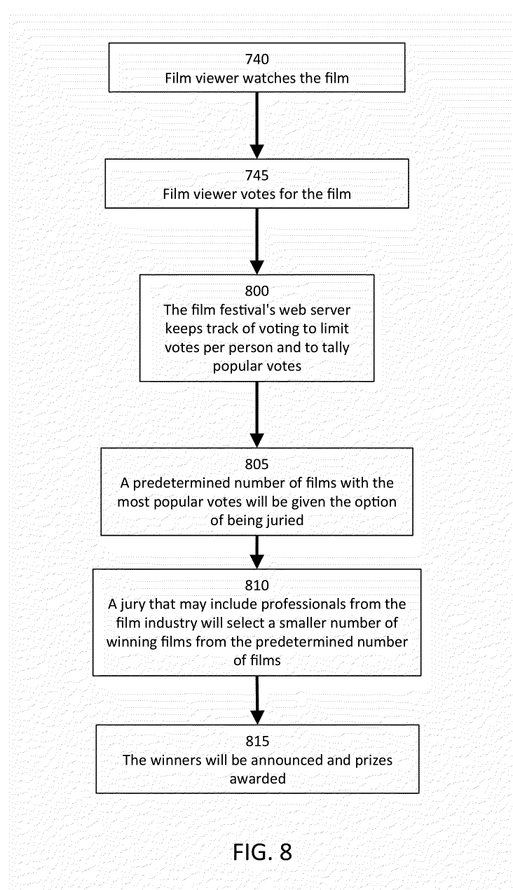

FIG. 8 is a flow chart showing actions executed to award a prize within the online film festival. The judging of submitted films can start with a viewer watching a film 740. The viewer can choose to vote for the film he or she has just watched 745, assuming that he or she is not blocked from doing so, based upon the number of previous votes, as discussed herein. The online film festival's server or software will keep track of the voting 800. Real-time indicators of which films are most popular can be posted, or the results of voting can be released periodically. Alternatively, the results of voting can be kept secret until after voting has ended or after the prizes have been awarded. Voting will take place for a set time period, and can be accomplished through multiple means, such as social networking sites, online clicking, online voting, and the like. The set time period can be 30 days, 45 days, 60 days, a year, or another specified amount of time. After the set time period, the films can be categorized by film genre and/or type (i.e. raw or professional), and the top vote getters can be awarded prizes. The top films, when ranked by votes received, can also be passed into a juried competition 805. The number of films selected to enter the juried competition can be set to a predetermined number, such as 5, 10, 15, 20, 25, 30, 50, or the like. Alternatively, the number of films selected to be evaluated by the jury can be a percentage of the whole, such as the top 5%, 10%, or any other percentage. Selection to be evaluated by the jury does not guarantee passing to the juried evaluation round. A fee may be required. Other requirements may be put forth instead of or in addition to the fee. Such other requirements include proof of ownership of intellectual property rights, indemnification agreements, and the like.

The jury can be, for example, composed of professionals in the film industry or other qualified personnel. The professional jury will select at least one winner from the juried films pool 810. The at least one winner can be a subset of the submitted films, such as one film, five films, three films, the top 1% of the juried films, the top 1% of all of the submitted films, or the like. Following this selection process, the at least one winner will be announced and the prizes awarded 815. The announcement can be made via a digital forum, such as the website, application or both the website and application, via an awards ceremony, via a web-cast press-release, or the like. Prizes can include trophies, certificates, money, licensing agreements, other transactional agreements favorable to the winner, and the like. Transactional agreements may include representation of the winning film and/or the winning filmmaker by the film festival or an entity associated with the film-festival, such that there is an agency relationship between the filmmaker and the film festival or related entity.

The implementations set forth in the foregoing description do not represent all implementations consistent with the subject matter described herein. Instead, they are merely some examples consistent with aspects related to the described subject matter. Wherever possible, the same reference numbers will be used throughout the drawings to refer to the same or like parts.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output and any order of steps that accomplishes the results herein. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the subject matter described herein can be implemented on a computer having a display device, e.g., a CRT (cathode ray tube), touchscreen or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other in a logical sense and typically interact through a communication network. The relationship of client and server arises by virtue of computer programs running on the respective computers and having a client-server relationship to each other.

Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. Similarly, elements located on the front, back, side, top, or bottom of an embodiment or implementation are to be understood as relatively positioned, unless otherwise specified. Other embodiments can be within the scope of the claims.

What is claimed is:

1. A system comprising:
a digital interface accessible by a computer from a computer network, the digital interface comprising:
a receiving portion configured to receive a first film from a first submitter and a second film from a second submitter, the first film and the second film each being received as a digital representation of a set of images;
an information submission portion to receive information about the first and second submitters;
a viewing portion configured to present to one or more viewers the first film and the second film, the viewing portion further comprising an input portion that is configured to receive from the one more viewers a vote, a comment, and/or funds associated with the first film and the second film, the funds being collected from at least one of the one or more viewers after presentation of the first film or the second film;
a timer associated with each of the first film and the second film, the timer tracking a time remaining to vote on the respective first or second film;
a vote tallying portion that tracks a number of votes associated with the first and second film, the vote tallying portion further having an input for receiving data from a jury related to the first and second films, the vote tallying portion configured to determine a winning film based on the number of votes or the data from the jury; and
a digital forum provided by the computer network, the digital forum presenting data representing the winning film, the digital forum further generating promotions for the winning film, and designating a prize associated with the winning film.

2. The system of claim 1, wherein the digital interface comprises a built in film school.

3. The system of claim 1, wherein the digital interface comprises an editing service.

4. The system of claim 1, wherein the digital interface comprises an application associated with a handheld computing device.

5. The system of claim 1, wherein no funds are collected from the viewer prior to the viewer viewing the submitted film.

6. The system of claim 1, wherein the vote tallying system comprises a system to accept votes through a text message sent through a cellular phone.

7. The system of claim 1, wherein the digital interface comprises the ability to accept payment through a text message sent through a cellular phone.

8. The system of claim 1, wherein the digital interface comprises a website, a dedicated application, or both a website and a dedicated application.

9. A method for conducting a film contest comprising:
receiving, via a digital interface a first film from a first submitter, and a second film from a second submitter to submit, the first film and the second film each being received as a digital representation of a set of images;
accepting information about the first film and the second film via a submission portion of the digital interface from the first submitter and second submitter, respectively;
presenting, via a viewing portion of the digital interface, options for a user to search and find at least one of the submitted films to view;
viewing via the viewing portion of the digital interface by the user the at least one of the submitted films;
accepting at least one vote via an input portion of the digital interface from the user, the at least one vote being associated with at least one of the submitted films;
tallying a number of votes associated with the first and second films using a vote tallying portion of the digital interface; and
generating a contest winner from the at least two submitted films, the contest winner being determined by the at least one vote or a jury.

10. The method of claim 9, further comprising characterizing the first and second films based upon the information provided while submitting each film.

11. The method of claim 9, further comprising using the vote tallying portion to determine which of the first and second films has the most votes.

12. The method of claim 9, wherein generating the contest winner comprises selecting a portion of the submitted films for the jury based upon the at least one vote.

13. The method of claim 12, further comprising submitting the first and second films to the jury using pre-determined selection criteria and announcing the contest winner via a digital forum associated with the digital interface.

14. A method comprising:
providing a digital interface that allows a first submitter to submit a first film, at least a second submitter to submit a second film, and a viewer to view the at least two submitted films;
accepting the at least two submitted films via the digital interface;
presenting options for a user to search and find at least one of the submitted films to view;
viewing via the digital interface by the user the at least one of the submitted films;
accepting at least one vote via the digital interface from the user, the at least one vote being associated with at least one of the submitted films;
selecting via a vote tallying portion of the digital interface a subset of the submitted films for a jury process based upon the at least one vote;
subjecting the subset of the submitted films to the jury process using pre-determined judging criteria;
generating a contest winner from the subset of the submitted films; and
announcing the contest winner via a digital forum associated with the digital interface.

15. The method of claim 14, further comprising accepting a payment associated with one of the submitted films from the viewer, the payment being made via the digital interface after the viewer has viewed the one of the submitted films.

16. The method of claim 15, wherein the payment causes the vote to be cast for the one of the submitted films.

17. The method of claim 14, wherein a payment can be contributed via a text message using a cellular phone.

18. The method of claim 17, wherein the payment via the text message causes the vote to be cast for the one of the submitted films.

19. The method of claim 14, wherein the digital interface comprises a dedicated application on a mobile computing device.

20. The method of claim 14, further comprising providing an editing service through the digital interface.
